(19) United States
(12) Patent Application Publication
(10) Pub. No.: US 2013/0314336 A1
(43) Pub. Date: Nov. 28, 2013

(54) METHODS OF RHYTHM TOUCH UNLOCK AND RELATED ELECTRONIC DEVICE

(71) Applicant: WISTRON CORPORATION, New Taipei City (TW)

(72) Inventor: Tung-Sheng Ting, New Taipei City (TW)

(73) Assignee: WISTRON CORPORATION, New Taipei City (TW)

(21) Appl. No.: 13/668,338

(22) Filed: Nov. 5, 2012

(30) Foreign Application Priority Data
May 23, 2012 (TW) 101118316

(51) Int. Cl. G06F 3/041

(52) U.S. Cl. 345/173

(57) ABSTRACT

An operating method of rhythm touch unlock is disclosed in the present invention. The operating method includes starting a rhythm touch unlock function, reading a touch signal stream, analyzing each signal event of the touch signal stream, reading a predetermined parameter from a database, comparing the touch signal stream to the predetermined parameter, and executing a corresponding operation according to a comparison.

### BACKGROUND OF THE INVENTION

1. Field of the Invention

The present invention relates to a touch unlock method, and more particularly, to an operating method and a setting method of rhythm touch unlock and a related electronic device.

2. Description of the Prior Art

With the advanced technology, the smart phone can display web information the same as a personal computer, and include independent operating system and fluent operating interface, so that the smart phone becomes popular in the market. Generally, the smart phone includes a touch panel. The touch panel not only can display image information, but also can be an inputting interface via a virtual keyboard. For locking an inputting function of the touch panel when the smart phone is not in use, the conventional smart phone utilizes a slide unlocking method to release a functional constraint of the touch panel. However, the slide unlocking method is a widespread application in all kinds of the existing smart phone. Thus, design of a new method different from the conventional slide unlocking method, so as to unlock the functional constraint of the touch panel conveniently is an important issue in the mobile phone industry.

### SUMMARY OF THE INVENTION

The present invention provides an operating method and a setting method of rhythm touch unlock and a related electronic device for solving above drawbacks.

According to the claimed invention, an operating method of utilizing rhythm click to unlock a touch panel is disclosed. The operating method includes starting a rhythm touch unlock function, reading a touch signal stream, analyzing a touching area and a touching period of each signal event of the touch signal stream on the touch panel, reading a predetermined parameter from a database, comparing the touching area and the touching period of the signal event of the touch signal stream to the predetermined parameter, and executing a corresponding operation according to a comparison.

According to the claimed invention, executing the corresponding operation according to the comparison includes: executing an unlock program when the touch signal stream corresponds to the predetermined parameter.

According to the claimed invention, executing the corresponding operation according to the comparison includes: displaying a prompting message on the touch panel when the touch signal stream does not correspond to the predetermined parameter.

According to the claimed invention, the operating method further includes waiting a predetermined period after the touch signal stream is read, and analyzing each signal event of the touch signal stream after the predetermined period.

According to the claimed invention, the operating method further includes counting a detecting period, and reading the touch signal stream during the detecting period.

According to the claimed invention, the touch panel includes a plurality of touching areas. An initial position and a final position of each signal event are respectively located at the same touching area or at different touching areas of the touch panel.

According to the claimed invention, the operating method further includes analyzing generating time of the signal events of the touch signal stream, and determining the signal events are simultaneously generated on the corresponding touching areas when difference of the generating time between the adjacent signal events is substantially smaller than a threshold value.

According to the claimed invention, the signal event is generated by a single touch method or a multiple touch method, and the touch signal stream is composed of the signal events.

According to the claimed invention, a setting method of utilizing rhythm click to unlock a touch panel is disclosed. The setting method includes starting a setting program of a rhythm touch unlock function, reading and recording a touch signal stream, reading and recording another touch signal stream, comparing touching areas and touching periods of each signal event of the two touch signal streams, and executing a corresponding operation according to a comparison.

According to the claimed invention, an electronic device includes a touch panel, a memory and a controller. The touch panel includes a plurality of touching areas. The memory includes a database, and a predetermined parameter is stored inside the database. The controller is electrically connected to the touch panel and the memory. The controller reads a touch signal stream from the touch panel, analyzes a touching area and a touching period of each signal event of the touch signal stream on the touch panel, compares the signal event to the predetermined parameter, and executes an unlock program of the touch panel or displaying a prompting message on the touch panel according to a comparison.

The present invention can utilize the rhythm click to unlock the functional constraint of the touch panel. The setting method, the operating method and the related electronic device of the present invention have preferable security strength than a conventional unlocking technology. The present invention has advantages of the high protection strength of the unlock code and easy operation. The observer can not identify the correct unlock code by the glance, so the present invention can be popularly applied in the market of consumptive electronic device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an electronic device according to an embodiment of the present invention.

FIG. 2 is a setting flow chart of utilizing the rhythm click to unlock a touch panel according to a first embodiment of the present invention.

FIG. 3 is an operating flow chart of utilizing the rhythm click to unlock the touch panel according to the first embodiment of the present invention.

FIG. 4 is a setting flow chart of utilizing the rhythm click to unlock the touch panel according to a second embodiment of the present invention.

FIG. 5 is an operating flow chart of utilizing the rhythm click to unlock the touch panel according to the second embodiment of the present invention.

FIGS. 6A and 6B are setting flow charts of utilizing the rhythm click to unlock the touch panel according to a third embodiment of the present invention.

FIG. 7 is an operating flow chart of utilizing the rhythm click to unlock the touch panel according to the third embodiment of the present invention.

### DETAILED DESCRIPTION

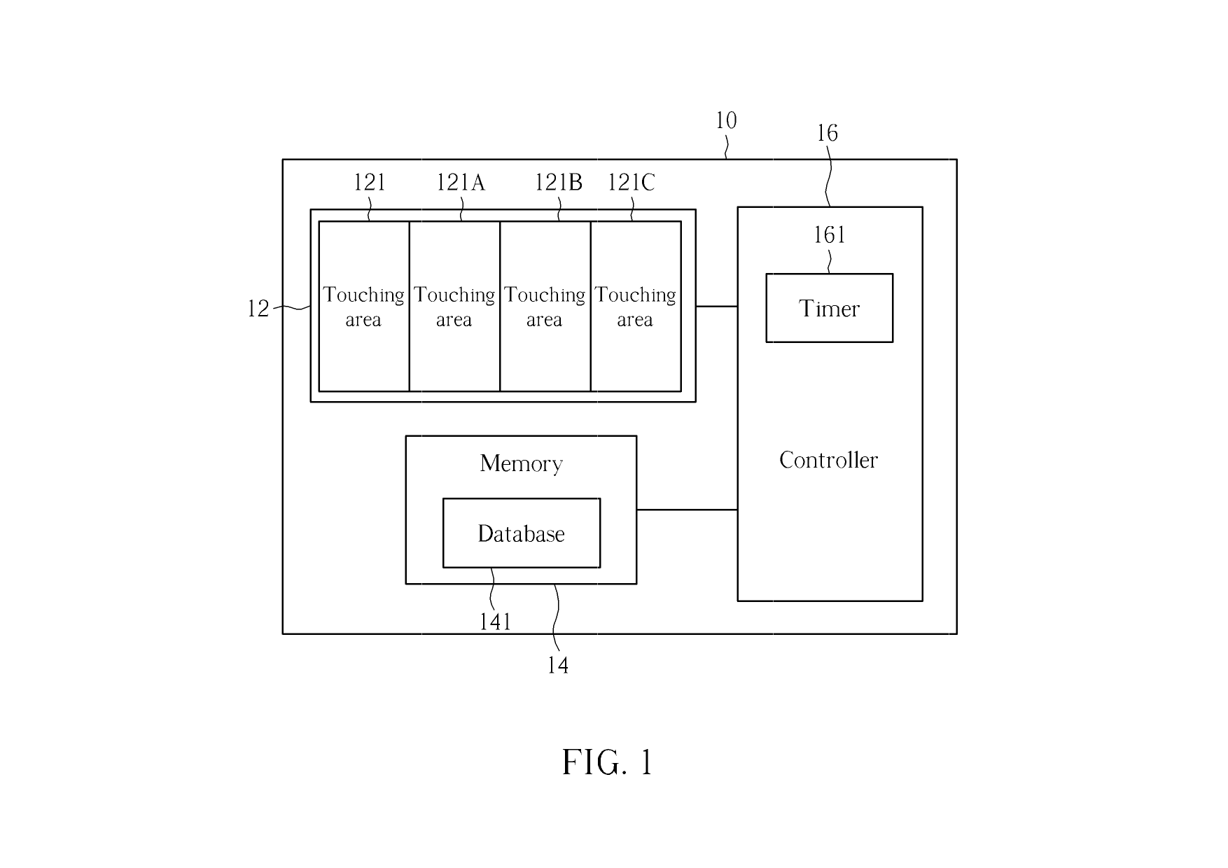

Please refer to FIG. 1. FIG. 1 is a functional block diagram of an electronic device 10 according to an embodiment of the present invention. The electronic device 10 includes a touch panel 12, a memory 14 and a controller 16. The controller 16 is electrically connected to the touch panel 12 and the memory 14. The touch panel 12 can be an inputting interface and a display interface of the electronic device 10. For unlocking a functional constraint of the touch panel 12, the electronic device 10 can utilize an unlock code by a rhythm click inputting method to execute touch unlock function. For example, the electronic device 10 can be a smart touch phone or a tablet computer. When the display interface of the electronic device 10 is locked, a user can click a series of rhythm on the touch panel 12. The controller 16 reads the rhythm, and immediately connects to a database 141 of the memory 14 for searching a predetermined code. According to a comparison of the inputting code (the rhythm inputted by the user) and the predetermined code (the unlock code), the controller 16 can determine whether the inputting code is correct or not, so as to unlock or to keep the functional constraint of the touch panel 12.

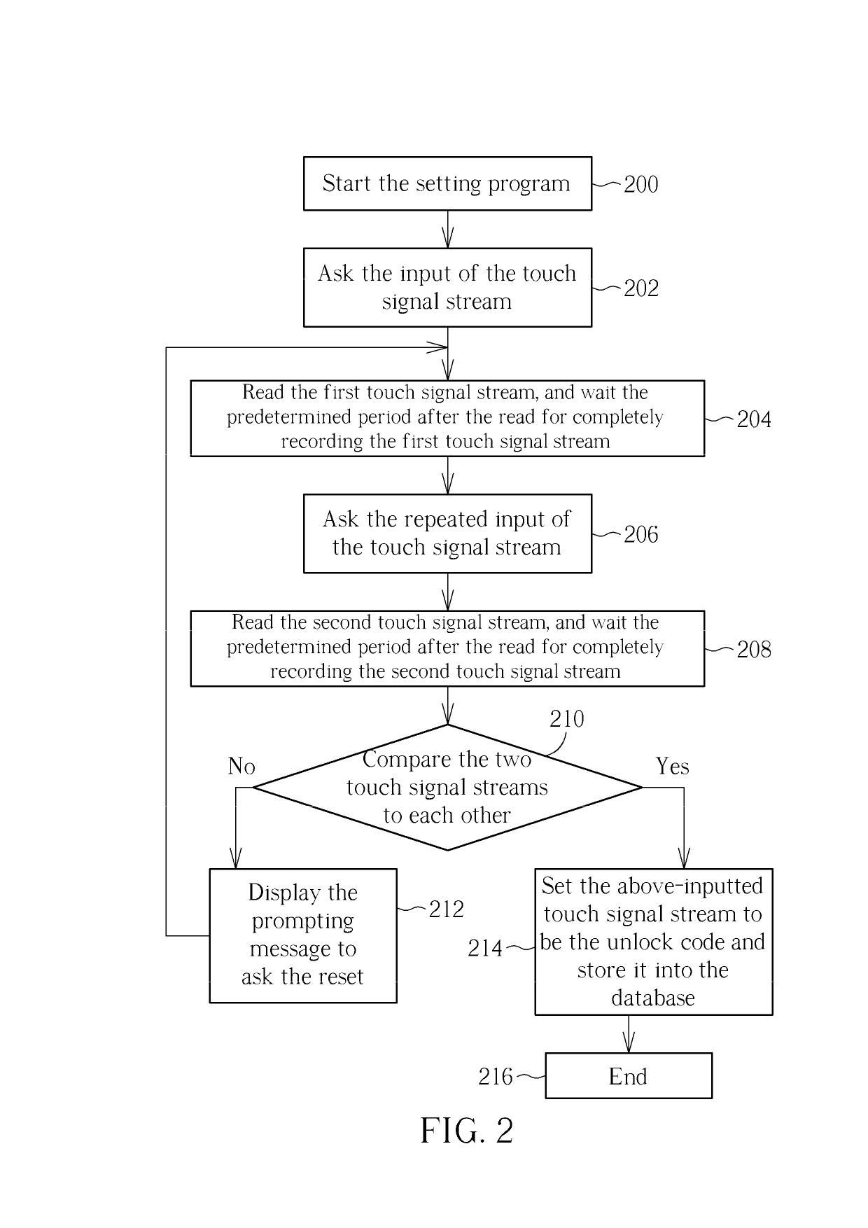

Please refer to FIG. 2. FIG. 2 is a setting flow chart of utilizing the rhythm click to unlock the touch panel 12 according to a first embodiment of the present invention. The setting method includes following steps:

Step 200: Start a setting program of a rhythm touch unlock function.

Step 202: Display a window on the touch panel 12 to ask an input of a touch signal stream by a single touch method.

Step 204: The controller 16 reads the touch signal stream, and utilizes a timer 161 to wait a predetermined period T after the touch signal stream is read, so as to completely record the touch signal stream.

Step 206: Another window is displayed on the touch panel 12 to ask the repeated input of the touch signal stream as mentioned above.

Step 208: The controller 16 reads the touch signal stream of the second input, and utilizes the timer 161 to wait the predetermined period T after the read is finished, so as to completely record the touch signal stream of the second input.

Step 210: The controller 16 compares touching periods of each signal event of the two touch signal streams to each other. Execute step 212 when the touch signal streams do not correspond to each other. Execute step 214 when the touch signal streams correspond to each other.

Step 212: The controller 16 displays a prompting message on the touch panel 12. The prompting message asks a reset and indicates that the touch signal streams do not correspond to each other.

Step 214: The controller 16 sets the above-inputted touch signal stream to be the unlock code, and stores the unlock code into the database 141 of the memory 14.

Step 216: End.

Detailed description is introduced as follow. First, the setting program of the electronic device 10 is started, and the touch panel 12 can selectively display an operating window to ask the input of the unlock code. In the first embodiment, the user can click the rhythm on the touch panel 12 by the single touch method. Period, frequency and positions of the rhythm can be arbitrarily inputted according to user's demand. An initial position (press), a final position (release) and a length of each signal event by click are not limited, and the touch signal stream can be composed of a plurality of signal events, so that the touch signal stream corresponds to the clicking rhythm.

The controller 16 can utilize the timer 161 to wait the predetermined period T when each signal event is end. As the next signal event is generated within the predetermined period T after the last signal event is end, the controller 16 can determine that the input of the touch signal stream has not been finished yet, so the controller 16 waits for the new signal event for completely recording the touch signal stream. As there is no signal event after the last signal event is end and a waiting time exceeds the predetermined period T, the controller 16 can determine that the input of the touch signal stream is finished, and stores the above-inputted touch signal stream into the database 141 of the memory 14. During the setting of the first embodiment, the electronic device 10 can ask twice inputs of the touch signal stream for verification, so as to prevent failed input by clicking error.

The verification is actuated when the controller 16 reads the two complete touch signal streams. The controller 16 compares the touching periods of each signal event of the two touch signal streams on the touch panel 12. As the two touch signal streams do not correspond to each other, the controller 16 displays the prompting message on the touch panel 12, so as to indicate failed information and to ask the reset of the unlock code. As the two touch signal streams correspond to each other, the controller 16 can set the above-inputted touch signal stream to be the unlock code, and store the unlock code into the database 141 of the memory 14 for backup.

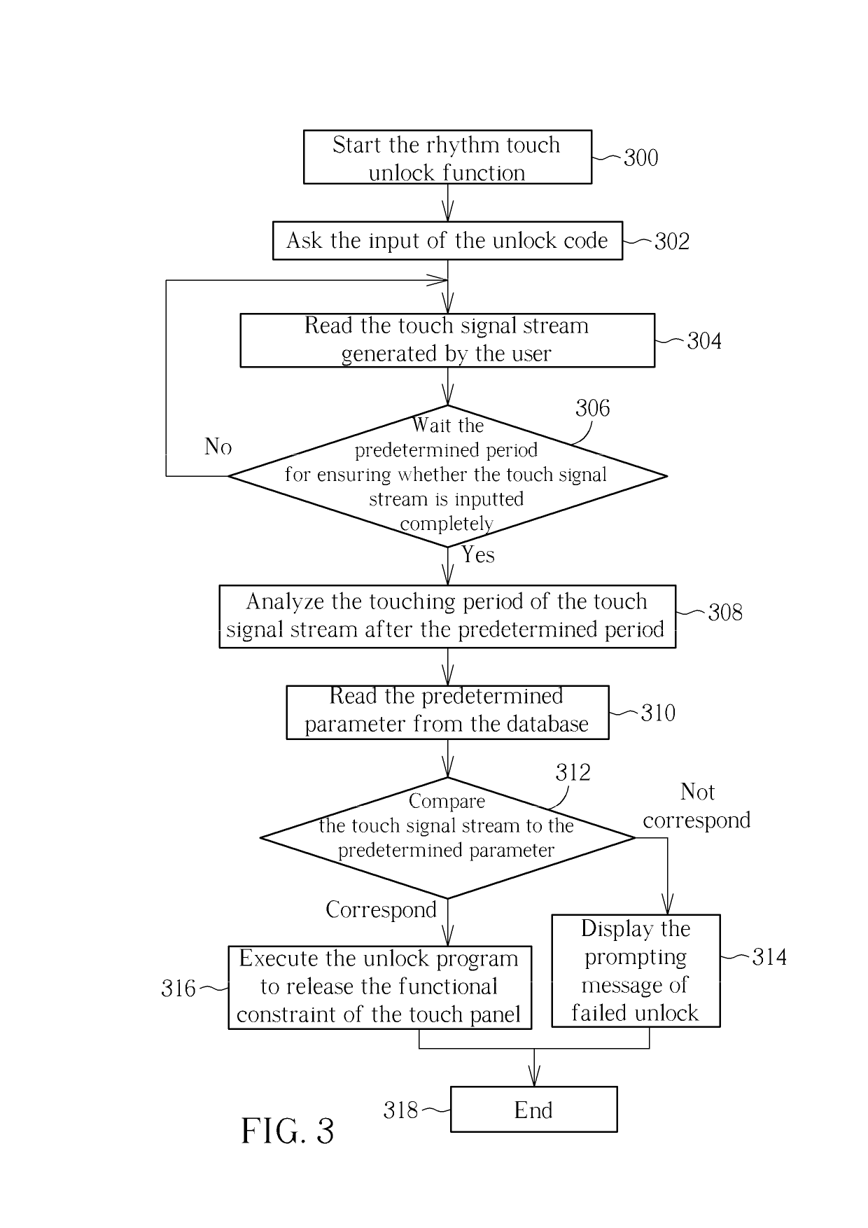

Please refer to FIG. 3. FIG. 3 is an operating flow chart of utilizing the rhythm click to unlock the touch panel 12 according to the first embodiment of the present invention. The operating method includes following steps:

Step 300: Start a rhythm touch unlock function.

Step 302: A window is displayed on the touch panel 12 to ask the input of the unlock code.

Step 304: The controller 16 reads the touch signal stream generated by the user on the touch panel 12.

Step 306: The controller 16 utilizes the timer 161 to wait the predetermined period T, so as to ensure whether the touch signal stream is inputted completely.

Step 308: The controller 16 analyzes the touching period of each signal event of the touch signal stream after the predetermined period T.

Step 310: The controller 16 reads a predetermined parameter (the unlock code generated by the setting program shown in FIG. 2) from the database 141.

Step 312: The controller 16 compares the touching period of each signal event of the touch signal stream to the predetermined parameter. Execute step 314 when the touch signal stream does not correspond to the predetermined parameter. Execute step 316 when the touch signal stream corresponds to the predetermined parameter.

Step 314: The controller 16 displays the prompting message on the touch panel 12.

Step 316: The controller 16 executes an unlock program to release the functional constraint of the touch panel 12.

Step 318: End.

Detailed description is introduced as follow. The controller 16 can start the rhythm touch unlock function when the electronic device 10 is opened, and the functional constraint of the touch panel 12 is released to be available after the rhythm touch unlock function is finished. First, the touch panel 12 displays the window to ask the input of the unlock code. In the first embodiment, the user can click the rhythm on the touch panel 12 by the single touch method, each click corresponds to the one signal event, and the touch signal stream can be composed of the plurality of signal events. The touch signal stream is utilized to compare with the unlock code stored inside the database 141 for the verification.

The controller 16 can utilize the timer 161 to wait the predetermined period T after each signal event is end. As the next signal event is generated within the predetermined period T after the last signal event is end, the controller 16 can determine that the input of the touch signal stream has not been finished yet, so the controller 16 waits the new signal event for completely recording the touch signal stream. As there is no signal event after the last signal event is end and the waiting time exceeds the predetermined period T, the controller 16 can determine that the input of the touch signal stream is finished, and stores the above-inputted touch signal stream into the database 141 of the memory 14.

In addition, the controller 16 can selectively utilize the timer 161 to count a detecting period T′ when the first signal event is generated, and can further read/record the touch signal stream clicked by the user during the detecting period T′. It is to say, the electronic device 10 of the present invention has a limitation that the input of the touch signal stream has to be finished within the detecting period T′, so as to prevent low functional convenience due to the copious unlock code.

The controller 16 can further analyze the touching period of each signal event of the touch signal stream after recording the complete touch signal stream. The controller 16 can search the predetermined parameter (the unlock code set by the user) from the database 141, and compare each signal event of the touch signal stream to the predetermined parameter. As the touch signal stream does not correspond to the predetermined parameter, the controller 16 can display the prompting message on the touch panel 12 for indicating information of “wrong code”. The electronic device 10 can be shut down for preventing information divulgence, or can display the window on the touch panel 12 to ask the input of the unlock code again, alternatively. As the touch signal stream corresponds to the predetermined parameter, the controller 16 can execute the unlock program to release the functional constraint of the touch panel 12, and then the user can input the other control command via the touch panel 12.

Positions of each signal event of the touch signal stream on the touch panel 12 are not limited in the setting method and the operating method of the first embodiment. The whole touch panel 12 is a single touching area, so the initial position and the final position of each signal event are located within the single touching area. However, the touch panel 12 of the present invention can include a plurality of touch areas 121, such as the touching areas 121A to 121C shown in FIG. 1, for enhancing protection strength of the rhythm touch unlock function. The initial position and the final position of each signal event can be preferably located at different touching areas, for example, the initial position can be located at the touching area 121A, and final position can be located at the touching area 121C. Therefore, the present invention not only can utilize the periodic variation of the plurality of signal events to generate the touch signal stream with rhythm, but also can provide variations of the touching period and the touching area of each signal event when slidably clicking the touch panel 12, so that complexity of the rhythm touch unlock function of the present invention can be increased effectively.

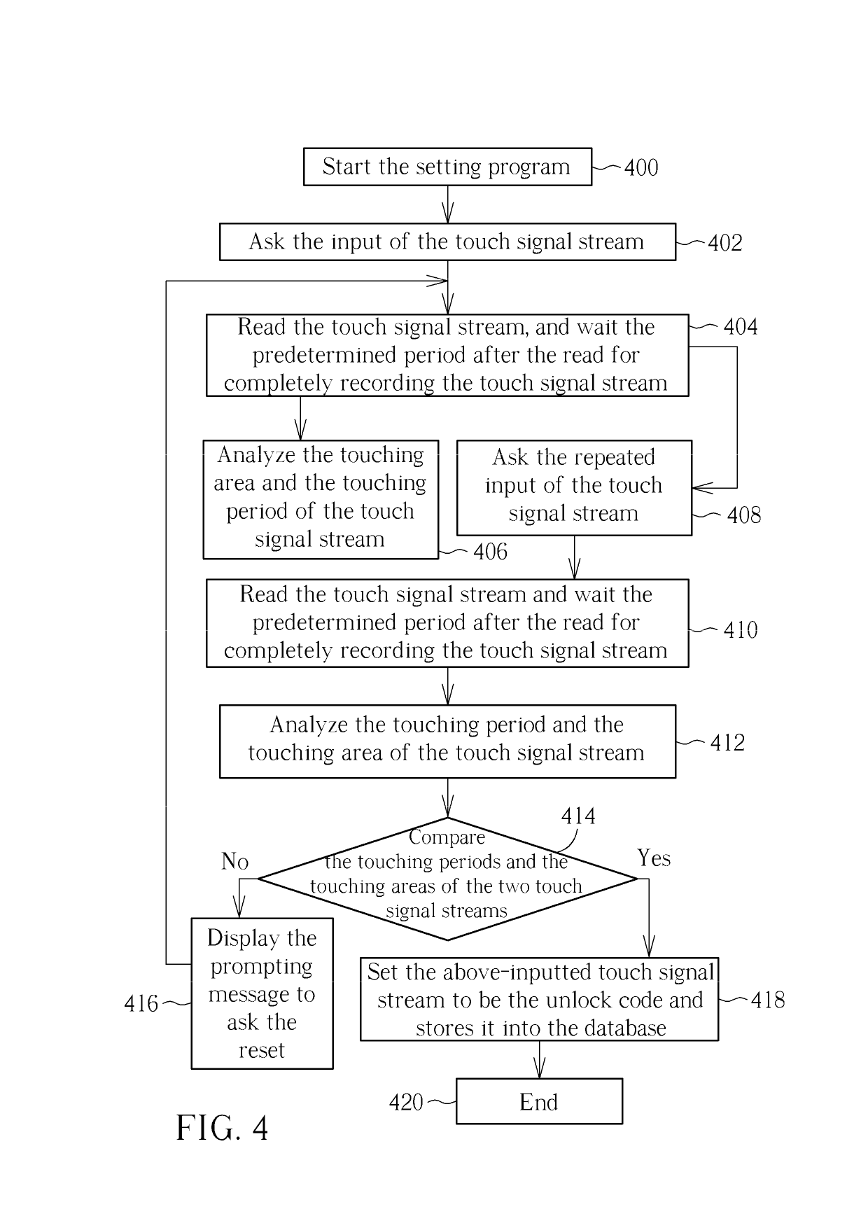

Please refer to FIG. 4. FIG. 4 is a setting flow chart of utilizing the rhythm click to unlock the touch panel 12 according to a second embodiment of the present invention. The setting method includes following steps:

Step 400: Start the setting program of the rhythm touch unlock function.

Step 402: Display the window on the touch panel 12 to ask the input of the touch signal stream by the single touch method.

Step 404: The controller 16 reads the touch signal stream, and utilizes a timer 161 to wait the predetermined period T after the touch signal stream is read, so as to completely record the touch signal stream. Then, steps 406 and 408 are executed simultaneously.

Step 406: The controller 16 analyzes the touching area and the touching period of each signal event of the touch signal stream, and stores a result into the database 141.

Step 408: Another window is displayed on the touch panel 12 to ask the repeated input of the touch signal stream as mentioned above.

Step 410: The controller 16 reads the touch signal stream of the second input, and utilizes the timer 161 to wait the predetermined period T after the read is finished, so as to completely record the touch signal stream of the second input.

Step 412: The controller 16 analyzes the touching period and the touching area of each signal event of the touch signal streams of the second input, and then stores a result into the database 141.

Step 414: The controller 16 compares the touching periods and the touching areas of each signal event of the two touch signal streams on the touch panel 12 to each other. Execute step 416 when the touch signal streams do not correspond to each other. Execute step 418 when the touch signal streams correspond to each other.

Step 416: The controller 16 displays the prompting message on the touch panel 12. The prompting message asks the reset and indicates that the touch signal streams do not correspond to each other.

Step 418: The controller 16 sets the above-inputted touch signal stream to be the unlock code, and stores the unlock code into the database 141 of the memory 14.

Step 420: End.

Difference between the second embodiment and the first embodiment is that the touch signal stream clicked in the second embodiment not only utilizes the touching period of each signal event to be a verification parameter, but also detects what touching areas of the touch panel 12 are the initial position and the final position of each signal event located. Therefore, an observer is hard to identify the correct unlock code by a glance at the slide click (the touch signal stream clicked by the user) even if unlocking operation is viewed, so as to increase security strength of the unlock code of the electronic device 10.

As shown in FIG. 4, the setting program of the second embodiment asks the twice inputs of the touch signal stream. The controller 16 can utilize the timer 161 to wait the predetermined period T after each signal event is generated, so as to determine whether the input of the touch signal stream is finished. After the touch signal stream is read, the controller 16 can analyze the touching area and the touching period of each signal event, and store the analysis result of the two touch signal streams into the database 141 for the backup (temporary information). When the two touch signal streams are inputted completely, the controller 16 can search the above-mentioned temporary information from the database 161, and then compare the touching areas and the touching periods of each signal event of the two touch signal streams on the touch panel 12 to each other. As the touch signal streams do not correspond to each other, the controller 16 asks the reset of the unlock code. As the touch signal streams correspond to each other, the controller 16 can set the above-inputted touch signal stream to be the unlock code, and further store the unlock code into the database 141.

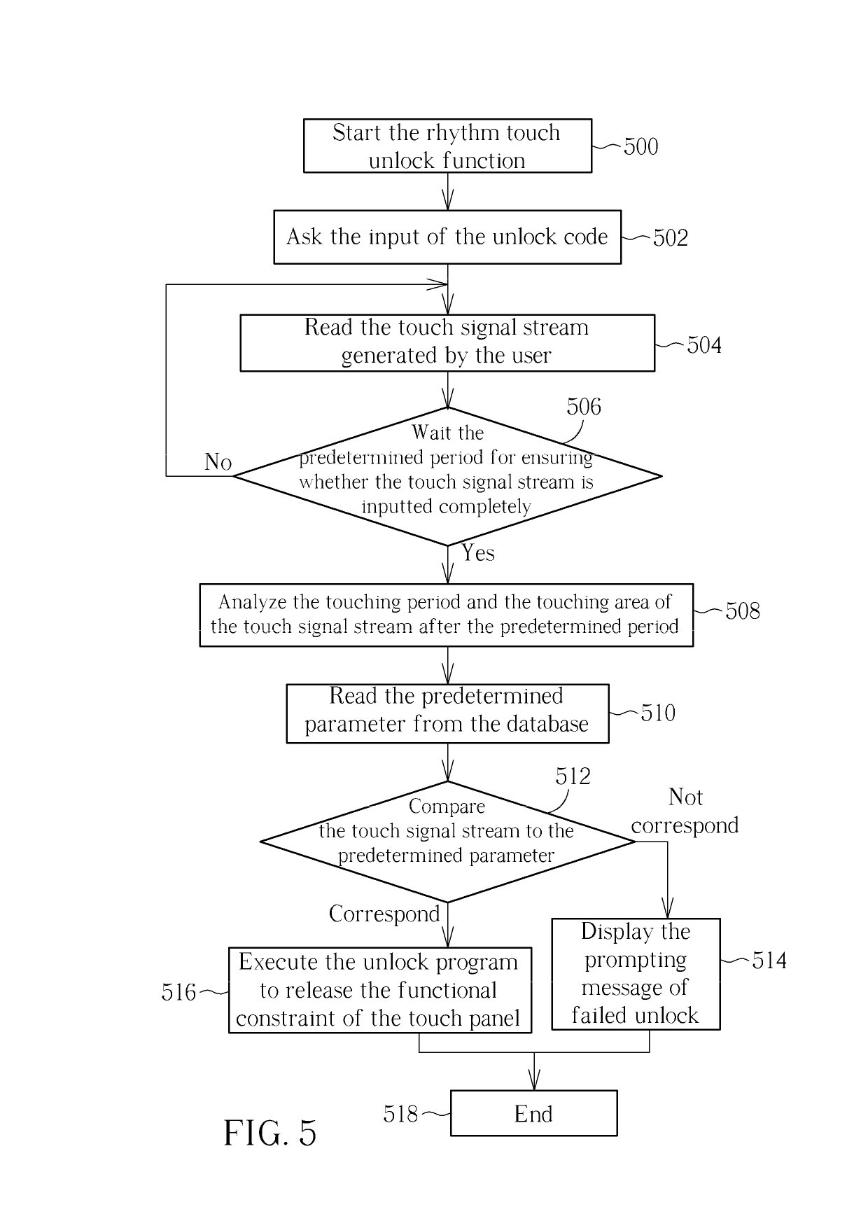

Please refer to FIG. 5. FIG. 5 is an operating flow chart of utilizing the rhythm click to unlock the touch panel 12 according to the second embodiment of the present invention. The operating method includes following steps:

Step 500: Start the rhythm touch unlock function.

Step 502: The window is displayed on the touch panel 12 to ask the input of the unlock code.

Step 504: The controller 16 reads the touch signal stream generated by the user on the touch panel 12.

Step 506: The controller 16 utilizes the timer 161 to wait the predetermined period T, so as to ensure whether the touch signal stream is inputted completely.

Step 508: The controller 16 analyzes the touching period and the touching area of each signal event of the touch signal stream on the touch panel 12 after the predetermined period T.

Step 510: The controller 16 reads the predetermined parameter (the unlock code generated by the setting program shown in FIG. 4) from the database 141.

Step 512: The controller 16 compares the touching period and the touching area of each signal event of the touch signal stream on the touch panel 12 to the predetermined parameter. Execute step 514 when the touch signal stream does not correspond to the predetermined parameter. Execute step 516 when the touch signal stream corresponds to the predetermined parameter.

Step 514: The controller 16 displays the prompting message on the touch panel 12.

Step 516: The controller 16 executes the unlock program to release the functional constraint of the touch panel 12.

Step 518: End.

Difference between the second embodiment and the first embodiment is that the controller 16 of the second embodiment can analyze the touching area and the touch period of each signal event of the touch signal stream on the touch panel 12. The controller 16 reads the initial position of each signal event, to determine what touching area 121 of the touch panel 12 does the signal event happen; and the controller 16 further reads the final position of each signal event, to determine what touching area 121 of the touch panel 12 does the signal event end. Then, the controller 16 can analyze time difference between the initial position and the final position to calculate the touching period of each signal event, so as to completely record area information and time information of each signal event. An amount of the verification parameters, such as the touching area and the touching period, of the signal event is increased for enhancing the security strength of the rhythm touch unlock function. The touch signal stream composed of the plurality of signal events can be a click track sliding over different areas of the touch panel 12, and the touch signal stream is clicked with the rhythm. Therefore, the present invention utilizes the click sliding track with rhythm variation to be the unlock code of the touch panel 12 in place of a single slide trace in the prior art.

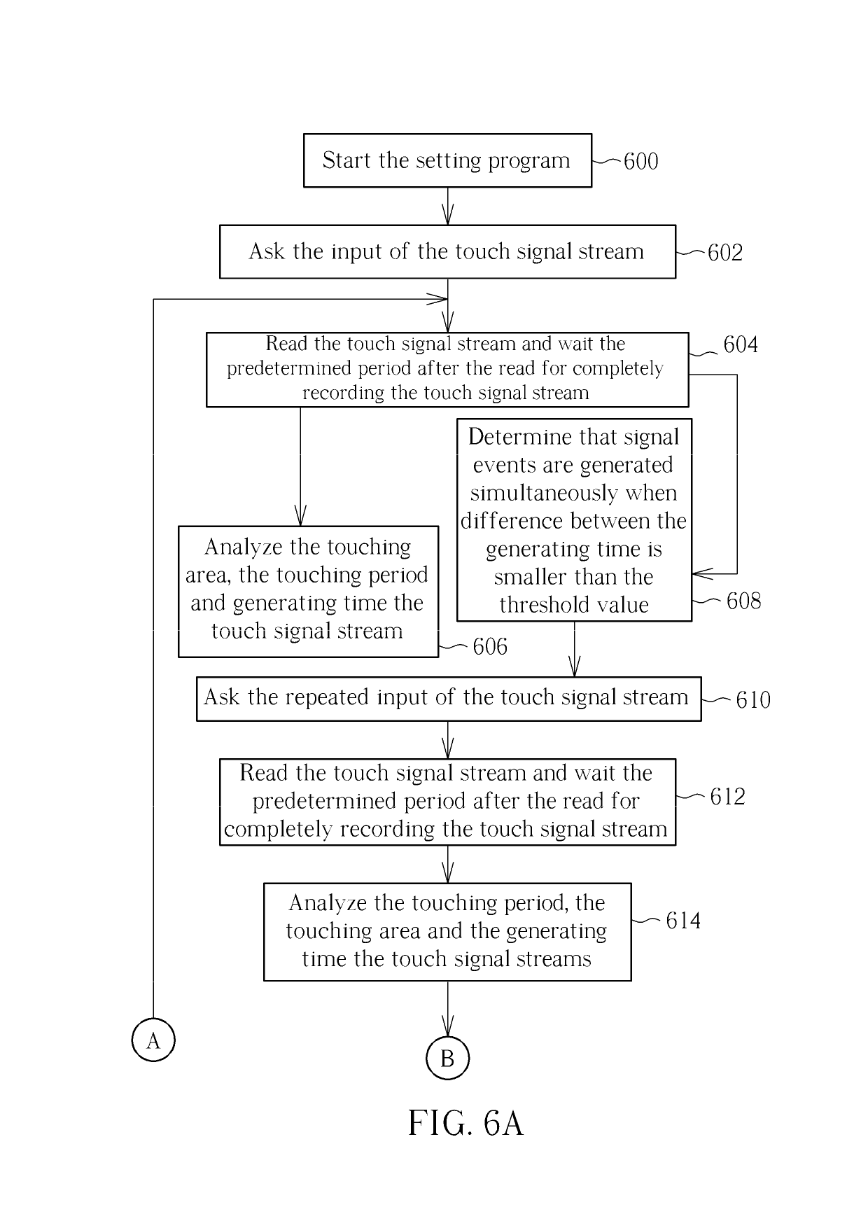

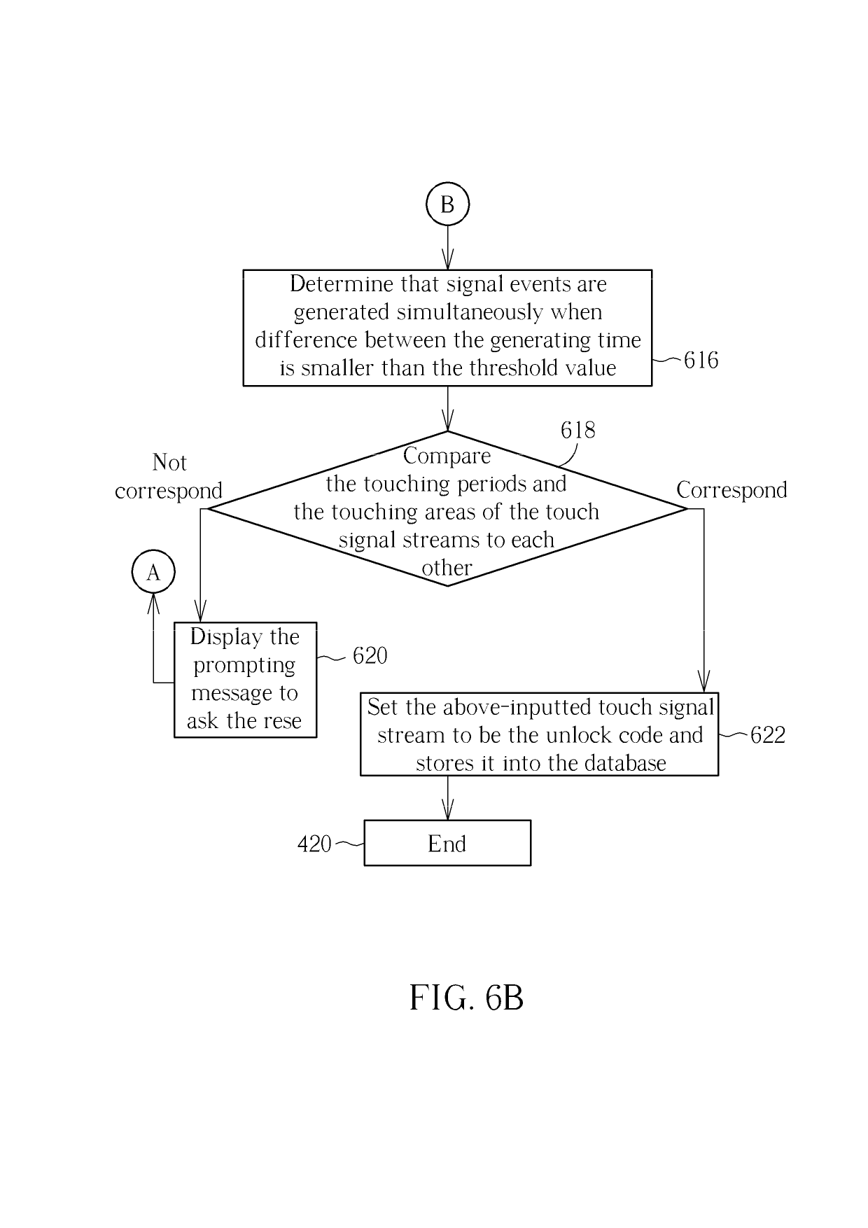

The first embodiment and the second embodiment utilize the single touch method to generate the signal events by rhythm click, and make the touch signal stream composed of the signal events to be the unlock code of the touch panel 12. Furthermore, the present invention can be applied to the electronic device 10 that includes the touch panel 12 having multiple touch function. Please refer to FIGS. 6A and 6B. FIGS. 6A and 6B are setting flow charts of utilizing the rhythm click to unlock the touch panel 12 according to a third embodiment of the present invention. The setting method includes following steps:

Step 600: Start the setting program of the rhythm touch unlock function.

Step 602: Display the window on the touch panel 12 to ask the input of the touch signal stream by the multiple touch method.

Step 604: The controller 16 reads the touch signal stream, and utilizes the timer 161 to wait the predetermined period T after the touch signal stream is read, so as to completely record the touch signal stream. Then, steps 606 and 608 are executed simultaneously.

Step 606: The controller 16 analyzes the touching area, the touching period and generating time of the signal events of the touch signal stream, and stores a result into the database 141.

Step 608: The controller 16 determines that two signal events are generated on the corresponding touching areas 121 simultaneously when difference of the generating time between the two signal events is substantially smaller than a threshold value.

Step 610: Another window is displayed on the touch panel 12 to ask the repeated input of the touch signal stream as mentioned above.

Step 612: The controller 16 reads the touch signal stream of the second input, and utilizes the timer 161 to wait the predetermined period T after the read is finished, so as to completely record the touch signal stream of the second input.

Step 614: The controller 16 analyzes the touching period, the touching area and the generating time of the signal events of the touch signal streams of the second input, and then stores a result into the database 141.

Step 616: The controller 16 determines that two signal events are generated on the touching area 121 simultaneously when difference of the generating time between the two signal events is substantially smaller than the threshold value.

Step 618: The controller 16 compares the touching periods and the touching areas of the signal events of the two touch signal streams on the touch panel 12 to each other. Execute step 620 when the touch signal streams do not correspond to each other. Execute step 622 when the touch signal streams correspond to each other.

Step 620: The controller 16 displays the prompting message on the touch panel 12. The prompting message asks the reset and indicates that the touch signal streams do not correspond to each other.

Step 622: The controller 16 sets the above-inputted touch signal stream to be the unlock code, and stores the unlock code into the database 141 of the memory 14.

Step 624: End.

The touch signal stream can be generated by the multiple touch method according to the setting program of the third embodiment. The controller 16 asks the twice inputs of the touch signal stream for verifying unity of the two touch signal streams, so as to set the unlock code of the touch panel 12. The user can click the touch panel 12 to generate the touch signal stream, and the controller 16 can utilize the timer 161 to wait the predetermined period T, so as to inspect an end of the touch signal stream. The other setting steps are the same as ones of the above-mentioned embodiments, and detailed description is omitted herein for simplicity.

The setting program of the third embodiment is applied to the multiple touch panel 12, the controller 16 not only analyzes the touching areas and the touching periods of the signal events of the touch signal stream on the touch panel 12, but also determines whether different signal events with close generating time are generated simultaneously or not according to the predetermined threshold value, so that relation between the different signal events can be distinguished. For example, the different signal events with the close generating time may be clicked by different rhythm or by the same rhythm. Thus, the third embodiment can utilize the multiple touch method to generate the plurality of signal events, and further analyze the touching area, the touching period and the generating time of each signal event, so as to compose the touch signal stream. Then, the controller 16 can execute the unlock code setting, or ask the unlock code reset according to the comparison of the twice inputs of the touch signal stream. Detailed description of the steps is the same as ones of the above-mentioned embodiments, and is omitted herein for simplicity.

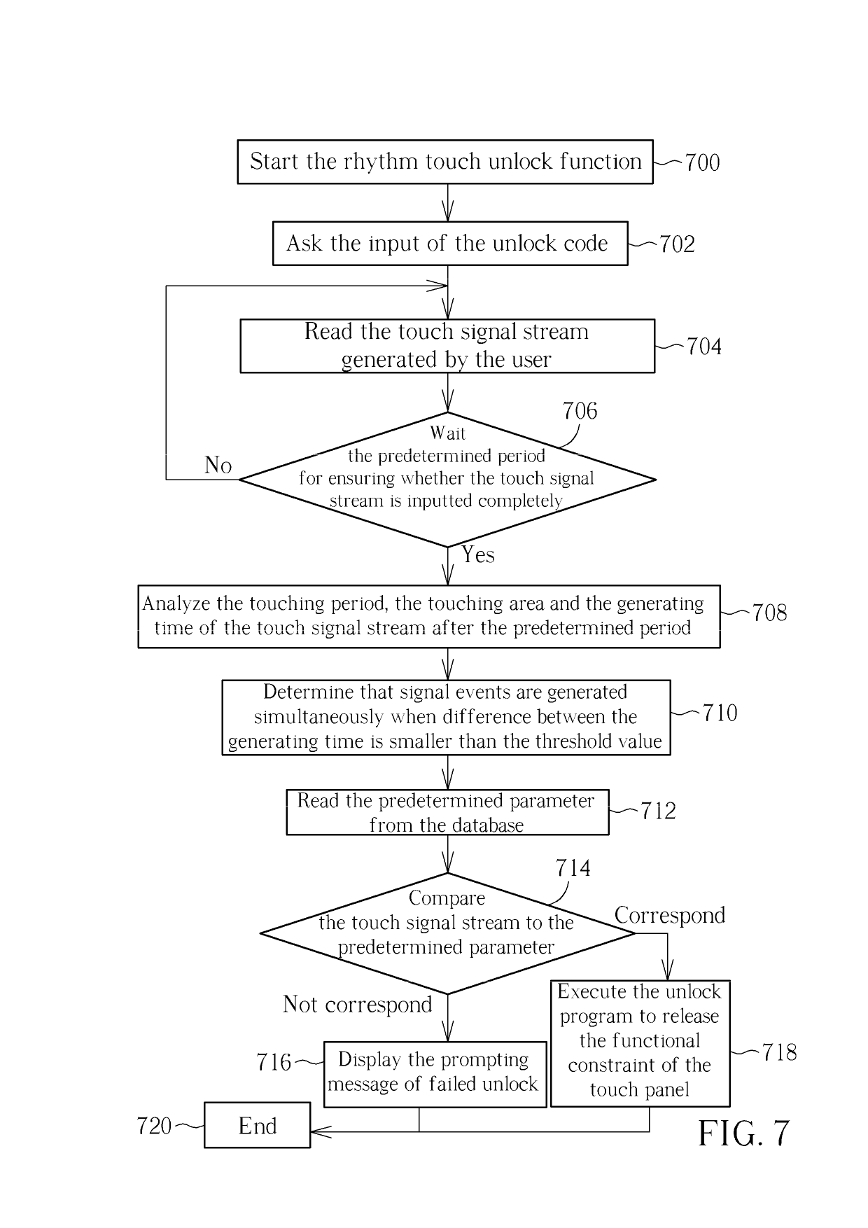

Please refer to FIG. 7. FIG. 7 is an operating flow chart of utilizing the rhythm click to unlock the touch panel 12 according to the third embodiment of the present invention. The operating method includes following steps:

Step 700: Start the rhythm touch unlock function.

Step 702: The window is displayed on the touch panel 12 to ask the input of the unlock code.

Step 704: The controller 16 reads the touch signal stream generated by the user on the touch panel 12.

Step 706: The controller 16 utilizes the timer 161 to wait the predetermined period T, so as to ensure whether the touch signal stream is inputted completely.

Step 708: The controller 16 analyzes the touching period, the touching area and the generating time of the signal events of the touch signal stream on the touch panel 12 after the predetermined period T.

Step 710: The controller 16 determines that the two signal events are generated on the corresponding touching areas 121 simultaneously when the difference of the generating time between the two signal events is substantially smaller than the threshold value.

Step 712: The controller 16 reads the predetermined parameter (the unlock code generated by the setting program shown in FIG. 6) from the database 141.

Step 714: The controller 16 compares the touching periods and the touching areas of the signal events of the touch signal stream on the touch panel 12 to the predetermined parameter. Execute step 716 when the touch signal stream does not correspond to the predetermined parameter. Execute step 718 when the touch signal stream corresponds to the predetermined parameter.

Step 716: The controller 16 displays the prompting message on the touch panel 12.

Step 718: The controller 16 executes the unlock program to release the functional constraint of the touch panel 12.

Step 720: End.

In the third embodiment, the touch signal stream generated by the multiple touch method can be used as the unlock code of the touch panel 12. The controller 16 can utilize the timer 161 to ensure whether the touch signal stream is inputted completely. After the touch signal stream is read, the controller 16 can determine that the adjacent signal events are generated simultaneously according to the difference of the generating time between the adjacent signal events. Then, the controller 16 can analyze the touching area and the touch period of each signal event, connect to the database 141 for capturing the predetermined parameter (the above-mentioned unlock code), and compare the touch signal stream to the predetermined parameter. The controller 16 can release the functional constraint of the touch panel 12, or display the prompting message on the touch panel 12 for asking re-operation of the unlock program according to the comparison. Difference between the third embodiment and the above-mentioned embodiments is that the touch signal stream generated in the third embodiment can include the plurality of signal events. Each signal event can include its unique parameters, such as the touching area and the touch period. Further, the plurality of signal events can be generated simultaneously or respectively.

For example, the user can simultaneously put three fingers on the touch panel 12, and move the fingers away respectively. The controller 16 can read the touch signal stream composed of three signal events. The touching period of the first signal event S1 can be t=0˜1, and the touching area of the first signal event S1 can be 121A to 121B; the touching period of the second signal event S2 can be t=0˜2, and the touching area of the second signal event S2 can be 121A to 121C; the touching period of the third signal event S3 can be t=0˜3, and the touching area of the third signal event S3 can be 121B to 121C. The signal events S1, S2 and S3 are generated simultaneously, and are respectively ended in sequence. The signal events S1, S2 and S3 are respectively generated on different areas of the touch panel 12, and the figures slide over the touch panel 12 to end the corresponding signal events on the other areas of the touch panel 12. Therefore, the third embodiment utilizes the multiple touch method to generate the touch signal stream for increasing comparison complexity. The parameter comparison includes the touching period of each signal event, the touching area of each signal event (or the sliding track), and the generating time of the plurality of signal events (for example, the signal events can be generated respectively, continuously or simultaneously). The operating method of utilizing the rhythm click to unlock the touch panel 12 according to the third embodiment of the present invention can complicate the parameter assembly of the touch signal stream, the unlock code is hard to be copied, and the security strength of the rhythm touch unlock function of the electronic device 10 can be enhanced effectively.

In conclusion, the present invention provides the setting method, the operating method and the related electronic device for utilizing the rhythm click to unlock the touch panel. In the first embodiment, the unlock code (the touch signal stream) inputted by the rhythm click can be composed of the plurality of signal events. Each signal event has the unique touching period, and can be distinguished from the other signal event easily, so as to increase complexity of the unlock code. In the second embodiment, the unlock code (the touch signal stream) is also composed of the plurality of signal events. Each signal event has the unique touching area and the unique touch period, therefore, the clicking position and the sliding track on the touch panel can be listed into the parameter comparison of the unlock code, so the second embodiment can optimize the security strength of the rhythm touch unlock function.

The first embodiment and the second embodiment are applied to the single touch panel, and the third embodiment further discloses the setting method and the operating method applied to the multiple touch method. The touch panel can be multiplably clicked to generate the plurality of signal events. The touch signal stream composed of the signal events can include several comparing parameters, such as the touching period, the touching area, the time relation between the different signal events. The signal events can be generated or be ended simultaneously. Thus the third embodiment can further enhance protection strength of the unlock code. Besides, the present invention can selectively add the other verification parameters into the rhythm touch unlock function, such as contacting dimensions or clicking intensity. An amount of the verification parameters can be increased according to type of the touch panel, the related setting method and the related operating method can be designed as above-mentioned steps, so as to adjust the protection strength of the unlock code by the multiplable rhythm click.

Comparing to the prior art, the present invention can utilize the rhythm click to unlock the functional constraint of the touch panel. The setting method, the operating method and the related electronic device of the present invention have preferable security strength than a conventional unlocking technology. The present invention has advantages of the high protection strength of the unlock code and easy operation. The observer can not identify the correct unlock code by the glance, so the present invention can be popularly applied in the market of consumptive electronic device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An operating method of utilizing rhythm click to unlock a touch panel, the operating method comprising:
starting a rhythm touch unlock function;
reading a touch signal stream;
analyzing a touching area and a touching period of each signal event of the touch signal stream on the touch panel;
reading a predetermined parameter from a database;
comparing the touching area and the touching period of the signal event of the touch signal stream to the predetermined parameter; and
executing a corresponding operation according to a comparison.

2. The operating method of claim 1, wherein executing the corresponding operation according to the comparison comprises:
executing an unlock program when the touch signal stream corresponds to the predetermined parameter.

3. The operating method of claim 1, wherein executing the corresponding operation according to the comparison comprises:
displaying a prompting message on the touch panel when the touch signal stream does not correspond to the predetermined parameter.

4. The operating method of claim 1, further comprising:
waiting a predetermined period after the touch signal stream is read; and
analyzing each signal event of the touch signal stream after the predetermined period.

5. The operating method of claim 1, further comprising:
counting a detecting period; and
reading the touch signal stream during the detecting period.

6. The operating method of claim 1, wherein the touch panel comprises a plurality of touching areas, an initial position and a final position of each signal event are respectively located at the same touching area or at different touching areas of the touch panel.

7. The operating method of claim 1, further comprising:
analyzing generating time of the signal events of the touch signal stream; and
determining the signal events are simultaneously generated on the corresponding touching areas when difference of the generating time between the adjacent signal events is substantially smaller than a threshold value.

8. The operating method of claim 1, wherein the signal event is generated by a single touch method or a multiple touch method, and the touch signal stream is composed of the signal events.

9. A setting method of utilizing rhythm click to unlock a touch panel, the setting method comprising:
starting a setting program of a rhythm touch unlock function;
reading and recording a touch signal stream;
reading and recording another touch signal stream;
comparing touching areas and touching periods of each signal event of the two touch signal streams; and
executing a corresponding operation according to a comparison.

10. The setting method of claim 9, wherein executing the corresponding operation according to the comparison:
setting the touch signal stream as an unlock code when the two touch signal streams corresponds to each other.

11. The setting method of claim 9, wherein executing the corresponding operation according to the comparison:
displaying a prompting message to ask an input of the touch signal stream when the two touch signal streams do not correspond to each other.

12. The setting method of claim 9, further comprising:
waiting a predetermined period after the touch signal stream is read; and
recording the touch signal stream after the predetermined period.

13. The setting method of claim 9, wherein the touch panel comprises a plurality of touching areas, an initial position and a final position of each signal event are respectively located at the same touching area or at different touching areas of the touch panel.

14. The setting method of claim 9, further comprising:
analyzing generating time of the signal events of the touch signal stream; and
determining the signal events are simultaneously generated on the corresponding touching areas when difference of the generating time between the adjacent signal events is substantially smaller than a threshold value.

15. The setting method of claim 9, wherein the signal event is generated by a single touch method or a multiple touch method, and the touch signal stream is composed of the signal events.

16. An electronic device comprising:
a touch panel, the touch panel comprising a plurality of touching areas;
a memory, the memory comprising a database, a predetermined parameter being stored inside the database; and
a controller electrically connected to the touch panel and the memory, the controller reading a touch signal stream from the touch panel, analyzing a touching area and a touching period of each signal event of the touch signal stream on the touch panel, comparing the signal event to the predetermined parameter, and executing an unlock program of the touch panel or displaying a prompting message on the touch panel according to a comparison.

17. The electronic device of claim 16, wherein the controller further reads two separate touch signal streams via the touch panel during setting, compares touching areas and touching periods of each signal event of the two touch signal streams, and sets an unlock code to be stored into the database or displaying a prompting message on the touch panel according to the comparison.

18. The electronic device of claim 16, wherein the controller comprises a timer, the controller utilizes the timer to wait a predetermined period, so as to analyze or to record each signal event of the touch signal stream after the touch signal stream is read, the controller further utilizes the timer to count a detecting period, and the controller reads the touch signal stream during the detecting period.

19. The electronic device of claim 16, wherein an initial position and a final position of each signal event are respectively located at the same touching area or at different touching areas of the touch panel.

20. The electronic device of claim 16, wherein the signal event is generated by a single touch method or a multiple touch method, the touch signal stream is composed of the signal events, and the controller further determines the signal events are simultaneously generated on the corresponding touching areas when difference of the generating time between the adjacent signal events is substantially smaller than a threshold value.
